(19) United States
(12) Patent Application Publication
(10) Pub. No.: US 2025/0177869 A1
(43) Pub. Date: Jun. 5, 2025

(54) INTERACTIVE REATIONSHIP GAME

(71) Applicant: Roderick Jeter, Decatur, GA (US)

(72) Inventor: Roderick Jeter, Decatur, GA (US)

(21) Appl. No.: 19/044,673

(22) Filed: Feb. 4, 2025

Related U.S. Application Data
(63) Continuation of application No. 17/976,928, filed on Oct. 31, 2022.
(60) Provisional application No. 63/275,718, filed on Nov. 4, 2021.

(51) Int. Cl. A63F 13/79; A63F 13/335; A63F 13/87

(52) U.S. Cl. CPC A63F 13/79; A63F 13/335; A63F 13/87; A63F 2300/308; A63F 2300/61

(57) ABSTRACT

The invention relates to a relationship game where all you have to do to win is play. Players follow step-by-step instructions that promote honest communication skills that allow both players to be heard. One big advantage of this method is that couples can manage their disagreements privately, without talking to friends, family, and counselors. In addition, if players are not able to agree, the players can then give ALL the details of the issue (both sides of the story) to others for survey.

### COPYRIGHT STATEMENT

A portion of the disclosure of this patent document contains material that is subject to copyright protection. The copyright owner has no objection to the facsimile reproduction by anyone of the patent document or the patent disclosure as it appears in the Patent and Trademark Office patent file or records, but otherwise reserves all copyright rights whatsoever.

Trademarks used in the disclosure of the invention, and the applicants, make no claim to any trademarks referenced.

### BACKGROUND OF THE INVENTION

### 1) Field of the Invention

The invention relates to the field of relationship skill game, and, more particularly to a system or method that promotes honest communication skills that allow both players to be heard.

### 2) Description of Related Art

Currently the state of the art includes a number of Interactive Role-Playing Games which have been introduced into the market. Playing games is well known in the prior art with feature goals and similarities.

Games are a universal past time and games between both sexes, same sexes and intermixed couples and are known and occur in all ways each and every day. However, there is a need for a method/game or system which helps the couples to manage their disagreements privately, without talking to friends, family, and counselors.

Therefore, what is needed in the art is a system or method that promotes discussion between couples that allows them to manage their disagreements privately, without talking to friends, family, and counselors.

### BRIEF SUMMARY OF THE INVENTION

The instant invention one form is directed to a relationship game where all you have to do to win is play. Players follow step-by-step instructions that promote effective communication skills that allow both players to be heard. One big advantage of this method is that couples can manage their disagreements privately, without talking to friends, family, and counselors. It is easier to discuss issues without the expectation of drama. An important aspect of the process is that the method actually works when players follow the step-by-step instructions. If the couple is not able to settle their disagreement, the last step of the process allows the players to survey other people for their opinion on the issue. The value here is that the person being surveyed is provided both sides of the story (all the details). The survey can be conducted on paper (one person at a time) or on the web/phone application. Although less effective, the entire process can be done on the web/phone application. This process may be effective for co-workers or just two people with mutual goals. The main objective is to help couples to stay together . . . one issue at a time

An advantage of the present invention is that the method or system is in the form of a game to help people settle their disagreements. This is achieved by addressing one issue at a time. If they cannot agree, they are able to survey others to see who is being more reasonable. The people being surveyed will have both sides of the story, not just one side of the story from one person's perspective

### BRIEF DESCRIPTION OF THE DRAWINGS

A further understanding of the nature and advantages of particular embodiments may be realized by reference to the remaining portions of the specification and the drawings, in which like reference numerals are used to refer to similar components. When reference is made to a reference numeral without specification to an existing sub-label, it is intended to refer to all such multiple similar components.

FIG. 1 shows the game booklet of the instant invention;

FIG. 2 shows “this one issue” form of the instant invention;

FIG. 3 shows page 1 of the “this one detail” form used by player A and B of the instant invention;

FIG. 4 shows page 2 of the “this one detail” form used by player A and B of the instant invention;

The appendix has a detail disclosure of the invention.

Corresponding reference characters indicate corresponding parts throughout the several views. The exemplifications set out herein illustrate embodiments of the invention and such exemplifications are not to be construed as limiting the scope of the invention in any manner.

### DETAILED DESCRIPTION

While various aspects and features of certain embodiments have been summarized above, the following detailed description illustrates a number of exemplary embodiments in further detail to enable one skilled in the art to practice such embodiments. The described examples are provided for illustrative purposes and are not intended to limit the scope of the invention.

In the following description, for the purposes of explanation, numerous specific details are set forth in order to provide a thorough understanding of the described embodiments. It will be apparent to one skilled in the art however that other embodiments of the present invention may be practiced without some of these specific details. Several embodiments are described herein, and while various features are ascribed to different embodiments, it should be appreciated that the features described with respect to one embodiment may be incorporated with other embodiments as well. By the same token however, no single feature or features of any described embodiment should be considered essential to every embodiment of the invention, as other embodiments of the invention may omit such features.

In this application the use of the singular includes the plural unless specifically stated otherwise and use of the terms “and” and “or” is equivalent to “and/or,” also referred to as “non-exclusive or” unless otherwise indicated. Moreover, the use of the term “including,” as well as other forms, such as “includes” and “included,” should be considered non-exclusive. Also, terms such as “element” or “component” encompass both elements and components including one unit and elements and components that include more than one unit, unless specifically stated otherwise.

Lastly, the terms “or” and “and/or” as used herein are to be interpreted as inclusive or meaning any one or any combination. Therefore, “A, B or C” or “A, B and/or C” mean “any of the following: A; B; C; A and B; A and C; B and C; A, B and C.” An exception to this definition will occur only when a combination of elements, functions, steps or acts are in some way inherently mutually exclusive.

As this invention is susceptible to embodiments of many different forms, it is intended that the present disclosure be considered as an example of the principles of the invention and not intended to limit the invention to the specific embodiments shown and described.

The terms game, process, method and system are used interchangeably to mean the system of the instant invention.

The instant invention provides a simple system to minimize conflict and guide people to happier relationships. The system reduces the conflict between two individuals which can have a beneficial effect on problems that result in divorce and other conflicts. It does this by creating a nonconfrontational method where two parties can disclose their issues and rate how the issue affects them. The problem with conflict resolution can be specifically illustrated when one looks at the divorce rate and many of its effects that result in a multitude of social problems that can be elevated with a simple and easy to use conflict resolution method provided by the instant invention.

If the instant invention is used properly it would result in fewer single parent homes, reducing the high school dropout rate, reducing the teenage pregnancy rate, reducing drug abuse, reducing domestic violence. The world would be a much better place if couples are happier and staying together. The goal of the instant invention is to help couples settle disagreements among themselves without outside help. The couple can get the opinion of others via the survey step but this process ensures the respondent is given all the details, not just one side of the story.

The prior art does not provide for a system that encourages two-way communication between two or more parties and if they are unable to resolve their issue the system enables the players to survey other people for their opinion on the issue thereby helping them resolve the issue and promoting a better relationship.

The instant invention is a method in the form of a game to help people settle disagreements and allows the players to survey others for their opinion. It accomplishes this by providing a relationship game where all you have to do to win is play. Players follow step-by-step instructions that promote honest communication skills and allows both players to be heard. A significant advantage of this method is that couples can manage their disagreements privately, without talking to friends, family, and counselors. It makes it easier for the couple to discuss issues without the expectations of drama. An important aspect of the method is that the method actually works when players follow the step-by-step instructions. If the couple is not able to settle their disagreement, the last step of the process allows the players to survey other people for their opinion on the issue. The value of this last step is that the person being surveyed is provided both sides of the story (all the details). The survey can be conducted on paper (one person at a time) or on the web/mobile application. Although less effective, the entire process can be done using the web/mobile application. This process may be effective for co-workers or just two people with mutual goals. The main objective is to help couples to stay together . . . one issue at a time.

The instant invention also provides a method in the form of a game to help people settle their disagreements one issue at a time. If they cannot agree, they are able to survey others to see who is being more reasonable. A unique aspect of the game is that when people are surveyed, they receive both sides of the story, not just one side of the story from one person's perspective. This allows the respondent to be more deliberative in their evaluation and provide better council than if they are hearing only one side of the story.

Additionally, the instant invention provides a step-by-step process designed to help two people communicate more effectively so that they both get their points across while staying focused on the issue. This process helps the couple understand and feel better about each other, strengthening their bond and provides a simple and stress-free method to openly discuss issues and develop concrete resolution to an issue.

The instant invention also provides a step-by-step process which has a very high success rate in resolving conflict. This is a game where you cannot win alone. The relationship wins. People like having a medium which they can utilize to settle disagreements without drama and end with a survey if they desire to utilize outside advisors to help them cut through issues and resolve them.

The instant invention can be utilized using two different formats. A paper-based process or a computer application-based process. The game in the paper-based format is normally provided in the form of a booklet but individual sheets can be used. The survey portion can be completed in paper or by utilizing a computer-based application which can use either a laptop or other computer or a mobile device. The instant invention can also be converted to a computer application where the forms are presented using either a laptop or other computer or a mobile device. Another method envisioned is to create different media forms of the instant invention such as a television or online show. When a television show is used then the world can watch couples come up on stage and settle their disagreements without a need of a mediator. If the format is a YouTube channel, viewers can watch recordings of couples settling their issues using the instant invention process.

The players first must agree on one issue to settle and decide who will be the first player or player A or the second player or player B. The instant invention utilizes the following steps to maximize the problem resolution process:

Step 1: Each player of the game writes down one detail of an issue. This is a key step because the participants are focusing on one distinct detail of an issue which makes the solution of the distinct issue easier to solve. When an issue is divided into distinct details the distinct details are easier to solve individually and when they are resolved independently, they can resolve the overall issue or problem.

Step 2: Each player of the game ranks the one detail of an issue.

Step 3: The players can then restate what they believe is the distinct detail of the problem and the first player can confirm the second players understanding. This is done for both players.

Step 4: The second player can now rate how relevant the distinct detail is to them and this sets up a vehicle to negotiate the resolution of the distinct detail.

The players can then enter a second distinct detail with respect to the issue being explored and resolve that distinct detail in a similar method.

A typical game is played as follows:
a. Start: Together both players agree to resolve one issue where they disagree. On a “This One Issue” card, each player writes the issue in the form of a Yes or No question. An example: “Should we buy a new car?” You may agree to restart the game with a more appropriate question at any time. The players will continue by completing COLOR-CODED steps 1-14 in sequence on a “This One Detail” card.
b. Using the “This One Detail” card the players:
   i. Step 1—using multiple cards if you have more than one detail to support your position on the issue. The players privately document all the details that support their position on this one issue by writing just one detail per card in Step 1. For Example: “Our current car has 300,000 miles on it.” There can only be ONLY ONE DETAIL PER CARD.
   ii. Step 2—identify the player as either player A or player B.
   iii. Step 3—the player of this one detail indicates how relevant this detail is to the issue. On each card they write a number 0-10 with 0 meaning “Doesn't really matter” and 10 meaning “Clincher”. Before proceeding to step 4, each player combines all detail cards (both A+B) in order of relevance, highest to lowest. The “This One Detail” cards will be processed in this order, one-at-a-time.
   iv. Step 4—the first player of the first detail card reads the detail aloud and then flips and passes the card to the second player to continue at Step 4. The second player says, “What you are saying to me is . . . ” and restates what they understand the first is saying.
   v. Step 5—after restating the detail, the first player is then asked, “Is that right?” Once the first player confirms that the restatement is correct, the second player checks “Yes” and proceeds to Step 6. NOTE: Step 4 & 5 must be repeated until the first player confirms.
   vi. Step 6—The second player circles “IS” or “Is NOT” to indicate whether the first player's detail is true.
   vii. Step 7—The second player indicates how relevant to him/her the first player's detail is to the issue (Again, 0 meaning “Doesn't really matter” and 10 meaning “Clincher”).
   viii. Step 8—Staying focused on this one detail as it relates to the issue, the second player writes a short response here, and then reads it aloud, flips, and passes the card. NOTE: One side of each card is for the first player and the other side is for the Second player.
   ix. Step 9—The original first player of the card says, “What you are saying to me is . . . ” and restates what they understand the second player is saying.
   x. Step 10—After restating the response, the second player is then asked, “Is that right?” Once the second player confirms that the restatement is correct, the original first player can check “Yes” and proceed to Step 11. NOTE: Steps 9 & 10 must be repeated until the second player confirms.
   xi. Step 11—both players CALMLY discuss/debate the significance, relevance, and truth of this one detail, check the box when completed.
   xii. Step 12 & 13—If either party feels differently, understands better, or realizes something new, share your new insight and write it in the “Adjustments/Take Away” section.
   xiii. Step 14—Together both players decide if there was progress on “This One Detail” and if there was enough progress to win the game. If necessary, continue to the next relevant detail card and repeat steps 1-14; OR if “This One Detail” exposed a significant difference of opinion, return to “Start” to settle your disagreement on “This One Detail” by creating a new yes or no issue question on another “This One Issue” card. Then, complete steps 1-14 on new detail cards. Once the new issue has been settled, return to Step 12 to resume the process for this detail; OR move to the survey process.

The instant invention anticipates a situation where the two players cannot reach a consensus and the instant invention has a survey phase as part of the process. The concept is that When the players are able to come to an agreement during or after the survey, the relationship still wins.

The survey process starts by the first player and second player gathering all the cards and placing them in the order processed during steps 1-14.

The survey requires at least one additional third party or third participant. The game allows multiple third party or third participant and the survey process can be repeated for as many third party or third participant as need.

Step A: The players either together or separately present all the cards to the third participant and request a Yes or No answer to your “This One Issue” question. (This allows the third participant to have both sides of the story.)

Step B—Explain the process to the third participant. For example: Player A wrote on one side and Player B wrote on the other; the cards were processed in order of relevance; and we followed steps 1-14 on each detail card.

Step C—The players use hashmarks to record Yes and No responses in the bottom portion of the “This One Issue” card. Note: After the third participant has answered, fold the “This One Issue” card at the dotted line to hide the results from any other third party or third participants.

Step D—Repeat as many times as needed to win the game.

The system and method can be further used in a computerized application as described:

The instant invention can be envisioned as a method to help at least two players compromise with respect to an issue effecting at least two players comprising of the steps:
a. the at least two players comprise of a first player and a second player.
b. the first player logs into an application on a first smart device and the application sends a first smart device GPS location and a first smart device internet protocol address to the cloud application. The cloud application has a sanction list of user internet protocol IP addresses and their associated GPS locations to ensure that the first player is the actual player who is paired with the second player. This ensures that the player identity and privacy is maintained and that a person who is not authorized or intended to participate in a specific session is prevented for entering the session.
c. the second player logs into an application on a second smart device and the application sends a second smart device GPS location and a second smart device internet protocol address to the cloud application. The cloud application has a sanction list of user internet protocol IP addresses and their associated GPS locations to ensure that the first player is the actual player who is paired with the second player. This ensures that the player identity and privacy is maintained and that a person who is not authorized or intended to participate in a specific session is prevented for entering the session.
d. the cloud application compares the first smart device internet protocol address to a list of sanctioned internet protocol address to verify the first player;
e. the cloud application compares the second smart device internet protocol address to a list of sanctioned internet protocol address to verify the second player;
f. if the first player internet protocol address is in the sanction list, then the application on the first smart device is allowed to go to the next step;
g. if the second player internet protocol address is in the sanction list, then the application on the second smart device is allowed to go to the next step;
h. the first player and the second player agree on the issue to be resolved and the first player records the issue using the application on the first smart device and the second player records the issue using the application on the second smart device;
i. both players divide the issue to be resolved into distinct details which are distinct sub issues of the issue to be resolved and the first player records the distinct details using the application on the first smart device and the second player records the distinct details using the application on the second smart device;
j. the first player privately documents the items that support their position on the distinct details using the application on the first smart device;
k. the second player privately documents the items that support their position on the distinct details using the application on the second smart device;
l. the distinct details are processed in order of relevance by the application on the first smart device and the application on the second smart device. Alternatively, the distinct details can be processed in order of relevance by the application and displayed on one smart device;
m. the at least two players discuss and debate the distinct details one-at-a-time in a productive manner to resolve the distinct detail;
n. the first player selects the next the distinct detail using the application on the first smart device and the second player acknowledges the next distinct detail using the application on the second smart device;
o. the application on the first smart device and the application on the second smart device transfers control to step j unless there are no remaining the distinct detail and then control is transferred to step q, and
p. if player A and player B are not able to settle, then player A and player B survey at least a third individual for their opinion.

The method of the instant invention wherein the order of relevance is from the highest to lowest.

The method of the instant invention wherein the survey solicits the third individual solution to resolve the distinct issue.

The method of the instant invention wherein the survey solicits a third individual solution to resolve the issue.

The instant invention can alternatively be a method to help at least two players compromise with respect to an issue effecting the at least two players comprising of the steps:
a. the at least two players comprise of a first player and a second player;
b. the first player logs into an application on a first smart device and the application sends a first smart device GPS location and a first smart device internet protocol address to the cloud application;
c. the second player logs into an application on a second smart device and the application sends a second smart device GPS location and a second smart device internet protocol address to the cloud application;
d. the cloud application compares the first smart device internet protocol address to a list of sanctioned internet protocol address to verify the first player and if the first smart device internet protocol address is in the list of sanctioned internet protocol address the first smart device is allowed to enter the system;
e. the cloud application compares the second smart device internet protocol address to a list of sanctioned internet protocol address to verify the second player and if the second smart device internet protocol address is in the list of sanctioned internet protocol address the second smart device is allowed to enter the system;
f. if the first player internet protocol address is in the sanction list, then the application on the first smart device is allowed to go to the next step;
g. if the second player internet protocol address is in the sanction list, then the application on the second smart device is allowed to go to the next step;
h. the first player and the second player agree on the issue to be resolved and the first player records the issue using the application on the first smart device and transfers the issue to be resolved to the second smart device used by the second player records and displays it on the application on the second smart device;
i. the first player and the second players divide the issue to be resolved into distinct details which are distinct sub issues of the issue to be resolved and the first player records the distinct details using the application on the first smart device and the second player records the distinct details using the application on the second smart device;
j. the first player privately documents the items that support their position on the distinct details using the application on the first smart device;
k. the second player privately documents the items that support their position on the distinct details using the application on the second smart device;
l. the distinct details recorded on the first smart device are processed by the system in order of relevance to create a first list and the distinct details recorded on the second smart device are processed by the system in order of relevance to create a second list and the system combines the first list and the second list to form a third list and displays the third list on the first smart device;
m. the at least two players discuss and debate the third list distinct details in the third list one-at-a-time in a productive manner to resolve the distinct detail;
n. the system selects the next the distinct detail using the application on the first smart device and the second player acknowledges the next distinct detail using the application on the second smart device;
o. the application on the first smart device and the application on the second smart device transfers control to step j unless there are no remaining the distinct detail in the third list and then control is transferred to step p, and
p. if first player and second player are not able to settle, then first player and second player survey at least a third individual for their opinion.

The method of claim 5 wherein the order of relevance is from the highest to lowest.

The method of claim 5 wherein the survey solicits the third individual solution to resolve the distinct detail.

The method of claim 5 wherein the survey solicits a third individual solution to resolve the issue.

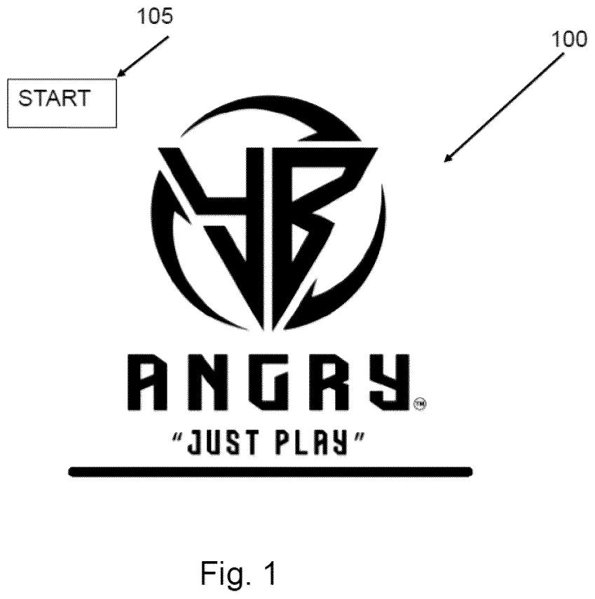

Referring now to the drawings, and more particularly to FIG. 1, there is shown an application home page 100 which provides allows the players to start 105 the application and access the forms of the instant invention.

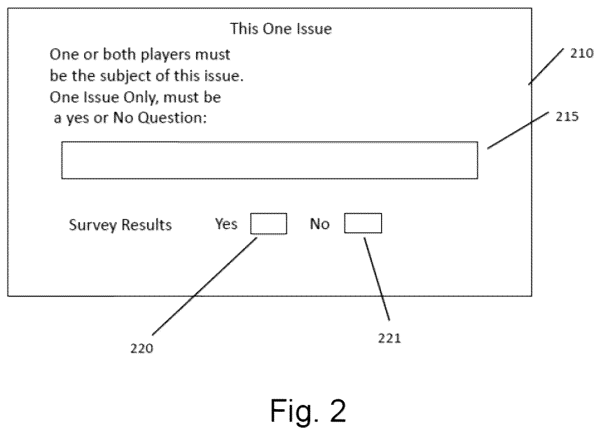

Referring to FIG. 2 which shows the application page “this one issue” form 210 of the instant invention. This form is used to record the issue that both individuals agree to attempt to resolve. It is also used to assist the individuals surveyed to understand the issue being discussed. This form can be filled out by either the first player (player A) and second player (player B). The player enters the issue in field 215. If the issue goes to a survey the user checks off the box 220 every time someone answers “YES” and checks off box 221. every time that someone answers NO. This provides space to document the responses to the yes or no survey.

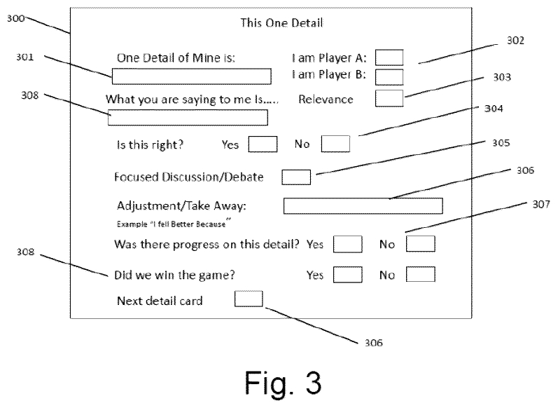

FIG. 3 shows the application page of the “this one detail” form 300 used by the first player or the second player of the instant invention. Field 301 documents only one detail that supports player A or B's position on the issue. Field 302 identifies the individual as player A or player B. Field 303 is a relevance score where the player that wrote the detail provides a relevance value to the issue. Field 309 prompts the first player (Player A or Player B) of the detail to restate the second players response to the detail written by the first player. Field 304 prompts the first player (player A) to verify the first players understanding of the second players response is accurate. Field 305 prompts players to discuss/debate first player (player A) and second player (player B) perspective on the detail. Field 306 provides an opportunity for the detail first player (player A) to record their takeaway with respect to the discussion. Field 307 provides a method to record progress with respect to the process and Field 308 is how the players indicate that they won the game.

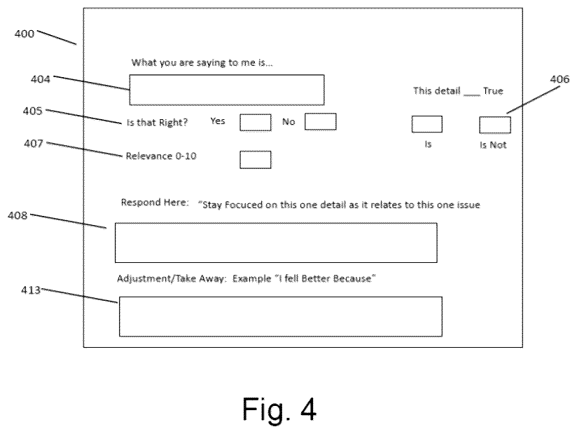

FIG. 4 shows the application page “this one detail” form 400 used by the by the first player (player A) or the second player (player B) of the instant invention. Field 404 provides a space and prompts the second player to speak aloud and record what they understand the detail is. Field 405 provides a space to record confirmation, Field 406 provides a way of recording if the individual feels the issue is true or not, field 407 is a relevance score where the second player provides a relevance value to this detail. Field 408 provides a space for the second player to record a response, Field 413 provides an opportunity for the individual to record their takeaway with respect to the discussion.

The instant invention keeps the players focused on one detail at a time. The instant invention provides a method where both parties can record the perceived details of issue and provide a response to the details in a conversational method which eliminates the heated discussions which normally occur during a traditional argument. This prevents the participants from damaging the relationship and provides a clear path for reconciliation and accommodation.

The instant invention provides a method in the form of a game to help people settle comprising:
a. The first player (player A) and second player (player B) agree on the issue (disagreement) to be resolved;
b. first player (player A) and second player (player B) privately documents the details that support their position on the issue (one detail per card);
c. details are processed in order of relevance (highest to lowest);
d. first player (player A) and second player (player B) are guided to discuss and debate the details one-at-a-time in a productive manner
e. if first player (player A) and second player (player B) are not able to settle, then player A and player B survey at least a third individual for their opinion

The instant invention can be captured in a computer program which allows the participants to have a digital or face to face discussion. When used in a digital form the application can include video or text-based chats as well as two-way data sharing. The system could also be integrated with applications such as skype, facetime or zoom so that participants can be in various locations and still work on resolving issues.

In some embodiments, the system, method or methods described above may be executed or carried out by a computing system including a tangible computer-readable storage medium, also described herein as a storage machine, that holds machine-readable instructions executable by a logic machine such as a processor or programmable control device to provide, implement, perform, and/or enact the above described methods, processes and/or tasks. When such methods and processes are implemented, the state of the storage machine may be changed to hold different data. For example, the storage machine may include memory devices such as various hard disk drives, CD, flash drives, cloud storage, or DVD devices. The logic machine may execute machine-readable instructions via one or more physical information and/or logic processing devices. For example, the logic machine may be configured to execute instructions to perform tasks for a computer program. The logic machine may include one or more processors to execute the machine-readable instructions. The computing system may include a display subsystem to display a graphical user interface (GUI) or any visual element of the methods or processes described above. For example, the display subsystem, storage machine, and logic machine may be integrated such that the above method may be executed while visual elements of the disclosed system and/or method are displayed on a display screen for user consumption. The computing system may include an input subsystem that receives user input. The input subsystem may be configured to connect to and receive input from devices such as a mouse, game controllers, video camera, camera, keyboard or gaming controller. For example, a user input may indicate a request that certain task is to be executed by the computing system, such as requesting the computing system to display any of the above-described information or requesting that the user input updates or modifies existing stored information for processing. A communication subsystem may allow the methods described above to be executed or provided over a computer network. For example, the communication subsystem may be configured to enable the computing system to communicate with a plurality of personal computing devices. The communication subsystem may include wired and/or wireless communication devices to facilitate networked communication. The described methods or processes may be executed, provided, or implemented for a user or one or more computing devices via a computer-program product such as via an application programming interface (API).

Since many modifications, variations, and changes in detail can be made to the described embodiments of the invention, it is intended that all matters in the foregoing description and shown in the accompanying drawings be interpreted as illustrative and not in a limiting sense. Furthermore, it is understood that any of the features presented in the embodiments may be integrated into any of the other embodiments unless explicitly stated otherwise. The scope of the invention should be determined by the appended claims and their legal equivalents.

In addition, the present invention has been described with reference to embodiments, it should be noted and understood that various modifications and variations can be crafted by those skilled in the art without departing from the scope and spirit of the invention. Accordingly, the foregoing disclosure should be interpreted as illustrative only and is not to be interpreted in a limiting sense. Further it is intended that any other embodiments of the present invention that result from any changes in application or method of use or operation, method of manufacture, shape, size, or materials which are not specified within the detailed written description or illustrations contained herein are considered within the scope of the present invention.

Insofar as the description above and the accompanying drawings disclose any additional subject matter that is not within the scope of the claims below, the inventions are not dedicated to the public and the right to file one or more applications to claim such additional inventions is reserved.

Although very narrow claims are presented herein, it should be recognized that the scope of this invention is much broader than presented by the claim. It is intended that broader claims will be submitted in an application that claims the benefit of priority from this application.

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A method to help at least two players compromise with respect to an issue effecting said at least two players comprising of the steps:
a. said at least two players comprise of a first player and a second player;
b. said first player logs into an application on a first smart device and said application sends a first smart device GPS location and a first smart device internet protocol address to the cloud application;
c. said second player logs into an application on a second smart device and said application sends a second smart device GPS location and a second smart device internet protocol address to the cloud application;
d. said cloud application compares said first smart device internet protocol address to a list of sanctioned internet protocol address to verify said first player;
e. said cloud application compares said second smart device internet protocol address to a list of sanctioned internet protocol address to verify said second player;
f. if the first player internet protocol address is in the sanction list, then said application on said first smart device is allowed to go to the next step;
g. if the second player internet protocol address is in the sanction list, then said application on said second smart device is allowed to go to the next step;
h. said first player and said second player agree on the issue to be resolved and said first player records said issue using said application on said first smart device and said second player records said issue using said application on said second smart device;
i. said first player and said second player divide said issue to be resolved into distinct details which are distinct sub issues of said issue to be resolved and said first player records said distinct details using said application on said first smart device and said second player records said distinct details using said application on said second smart device;
j. said first player privately documents the items that support their position on said distinct details using said application on said first smart device;
k. said second player privately documents the items that support their position on said distinct details using said application on said second smart device;
l. said distinct details recorded on said first smart device are processed by said system in order of relevance to create a first list and said distinct details recorded on said second smart device are processed by said system in order of relevance to create a second list and said system combines said first list and said second list to form a third list and displays said third list on said first smart device and on said second smart device;
m. said at least two players discuss and debate said distinct details in said third list one-at-a-time in a productive manner to resolve said distinct detail;
n. said system selects the next said distinct detail using said application on said first smart device and said second player acknowledges said next distinct detail using said application on said second smart device;
o. said application on said first smart device and said application on said second smart device transfers control to step j unless there are no remaining said distinct detail and then control is transferred to step q, and
p. if player A and player B are not able to settle, then player A and player B survey at least a third individual for their opinion.

2. The method of claim 1 wherein said order of relevance is from the highest to lowest.

3. The method of claim 1 wherein the survey solicits said third individual solution to resolve said distinct detail.

4. The method of claim 1 wherein the survey solicits a third individual solution to resolve said issue.

5. A method to help at least two players compromise with respect to an issue effecting said at least two players comprising of the steps:
a. said at least two players comprise of a first player and a second player;
b. said first player logs into an application on a first smart device and said application sends a first smart device GPS location and a first smart device internet protocol address to the cloud application;
c. said second player logs into an application on a second smart device and said application sends a second smart device GPS location and a second smart device internet protocol address to the cloud application;
d. said cloud application compares said first smart device internet protocol address to a list of sanctioned internet protocol address to verify said first player and if said first smart device internet protocol address is in said list of sanctioned internet protocol address said first smart device is allowed to enter the system;
e. said cloud application compares said second smart device internet protocol address to a list of sanctioned internet protocol address to verify said second player and if said second smart device internet protocol address is in said list of sanctioned internet protocol address said second smart device is allowed to enter the system;
f. if the first player internet protocol address is in the sanction list, then said application on said first smart device is allowed to go to the next step;
g. if the second player internet protocol address is in the sanction list, then said application on said second smart device is allowed to go to the next step;
h. said first player and said second player agree on the issue to be resolved and said first player records said issue using said application on said first smart device and transfers said issue to be resolved to said second smart device used by said second player records and displays it on said application on said second smart device;
i. said first player and said second players divide said issue to be resolved into distinct details which are distinct sub issues of said issue to be resolved and said first player records said distinct details using said application on said first smart device and said second player records said distinct details using said application on said second smart device;
j. said first player privately documents the items that support their position on said distinct details using said application on said first smart device;
k. said second player privately documents the items that support their position on said distinct details using said application on said second smart device;
l. said distinct details recorded on said first smart device are processed by said system in order of relevance to create a first list and said distinct details recorded on said second smart device are processed by said system in order of relevance to create a second list and said system combines said first list and said second list to form a third list and displays said third list on said first smart device;
m. said at least two players discuss and debate said third list distinct details in said third list one-at-a-time in a productive manner to resolve said distinct detail;
n. said system selects the next said distinct detail using said application on said first smart device and said second player acknowledges said next distinct detail using said application on said second smart device;
o. said application on said first smart device and said application on said second smart device transfers control to step j unless there are no remaining said distinct detail in said third list and then control is transferred to step p, and
p. if first player and second player are not able to settle, then first player and second player survey at least a third individual for their opinion.

6. The method of claim 5 wherein said order of relevance is from the highest to lowest.

7. The method of claim 5 wherein the survey solicits said third individual solution to resolve said distinct detail.

8. The method of claim 5 wherein the survey solicits a third individual solution to resolve said issue.

9. A method for using an interactive relationship game to solve an issue, the method comprising:
providing an interactive relationship game including;
an issue form for recording an issue that a first user and a second user agree to attempt to resolve, the issue form including:
an issue field; and
a survey field including a YES box and a No box;
a first detail form supporting a user position on the issue, the first detail form including:
a detail field for entering the detail of the issue;
an identification field for identifying the first user or the second user;
a relevance score field for entering a relevance value to the issue;
a restatement field for prompting of the restatement of the response to the detail written by the first player;
a verification field for entering verification of understanding of the response is accurate;
a discussion field for prompting discussion of the detail;
a takeaway field for providing an opportunity to record a takeaway with respect to the discussion;
a progress field for providing a method to record progress with respect to the process;
a won field for allowing the first or the second player to indicate that they won the game; and
a next field for allowing the first user or the second user to select the next card; and
a second detail form supporting a user position on the issue, the first detail form including:
a record field for providing a space and prompting the first user or the second user to speak aloud and record what they understand the detail is;
a confirmation field for recording confirmation;
a correctness field for recording if the first user or the second user feels the confirmation is true or not;
a detail relevance field for entering is a relevance score of a value to this detail;
a response field for recording a response; and
a second takeaway field for providing an opportunity record a user takeaway with respect to the discussion;
using the issue form to detail the issue; and
using the detail form and the second detail form to resolve the issue.

10. The method according to claim 9 wherein the detail form is on one side of a card and the second detail form is on an opposite side of the card.
